(19) United States
(12) Patent Application Publication
(10) Pub. No.: US 2009/0103706 A1
(43) Pub. Date: Apr. 23, 2009

(54) SYSTEMS AND METHODS FOR PROVIDING KEYWORD CALLING

(76) Inventor: Nicholas Zazza, Freehold, NJ (US)

Correspondence Address: MEREDITH & KEYHANI, PLLC, 330 MADISON AVE., 6TH FLOOR, NEW YORK, NY, 10017, US

(21) Appl. No.: 12/052,662

(22) Filed: Mar. 20, 2008

Related U.S. Application Data
(63) Continuation-in-part of application No. 11/877,638, filed on Oct. 23, 2007.
Application No. 11/877,638 is a continuation-in-part of application No. 11/877,640, filed on Oct. 23, 2007.
Application No. 11/877,640 is a continuation-in-part of application No. 11/877,642, filed on Oct. 23, 2007.

(51) Int. Cl. H04M 3/42

(52) U.S. Cl. 379/218.01

(57) ABSTRACT

Systems and methods for providing telephone calls according to internet keyword searches comprising the steps: providing a first user having a first user ID and phone number; providing a second user having a second user ID, a destination phone number, at least one selected paid keyword; accepting an internet request containing at least one keyword from the first user wherein the internet request contains at least one keyword identical to at least one paid keyword which is displayed as a highlighted keyword; when the first user clicks on the highlighted keyword a call request is initiated, calling the first user's phone number and the destination phone number associated with the paid keyword and connecting a telephone call between the first user and the second user according to the paid keyword and call request.

This application is a continuation in part and claims priority to patent application Ser. No. 11/877,638, 11/877,640 and 11/877,642 filed Oct. 23, 2007 which are incorporated herein by reference.

The present invention relates generally telecommunications and more specifically to systems and methods for providing telephone communications according to internet keyword searches.

Typically, phone calls are made by one user dialing the telephone number of a second user. Internet searches are one way in which a person may determine the phone number of a company or an individual. Many times, however, it takes many clicks and reviewing numerous websites to find the desired telephone number. The present invention removes the need to search through layers of websites to find a telephone number by associating web page keywords with a phone number.

Internet users using a search engine, typically enter search terms by keywords and a list of websites is displayed with a brief description of the relevant content. The user clicks on websites they think may be relevant and if they are looking for a good or service may look for a telephone number to call the owner of the website. Owners of websites also may use advertising programs, such as Google Keywords, to display their companies name when certain keywords are searched for. Again, this has the problem that it is requires constant monitoring and expensive web site optimization. Also, website owners may fear updating their website may impact their optimization. Accordingly, it is desirable to have optimization and search results that does not require expensive web site changes.

The present invention also provides for viral marketing by way of keywords associated with a phone number. Many people find it easier to remember a keyword than a phone number.

Accordingly, the present invention provides systems and methods for providing telephone calls and advertising through keywords.

### SUMMARY OF THE INVENTION

The present invention relates generally to systems and methods relating to telecommunications.

According to one embodiment, a computer implemented method of directly providing a telephone call according to internet keyword searches, the method comprising the steps of: providing a first user having a first user ID associated with a first phone number and a first user plan stored in a first computer based system; providing a second user having a second user ID associated with a destination phone number and a second user plan in the first computer based system, wherein the second user has selected at least one keyword to be associated with the second user ID associated with a destination phone number to provide at least one paid keyword; accepting an internet request on a second computer based system containing at least one keyword from the first user wherein the second computer based system highlights at least one keyword and wherein the internet request contains at least one keyword identical to the at least one paid keyword to provide a highlighted keyword; and wherein the first user clicks on the highlighted keyword a call request is initiated, the first computer based system calling the first phone number and the destination phone number associated with the paid keyword and connecting a telephone call between the first user and the second user according to the paid keyword and the call request.

These and other features, aspects and advantages of the present invention will become better understood with reference to the following description and claims.

### BRIEF DESCRIPTION OF THE DRAWINGS

FIGS. 1-36 depict the present invention.

### DETAILED DESRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

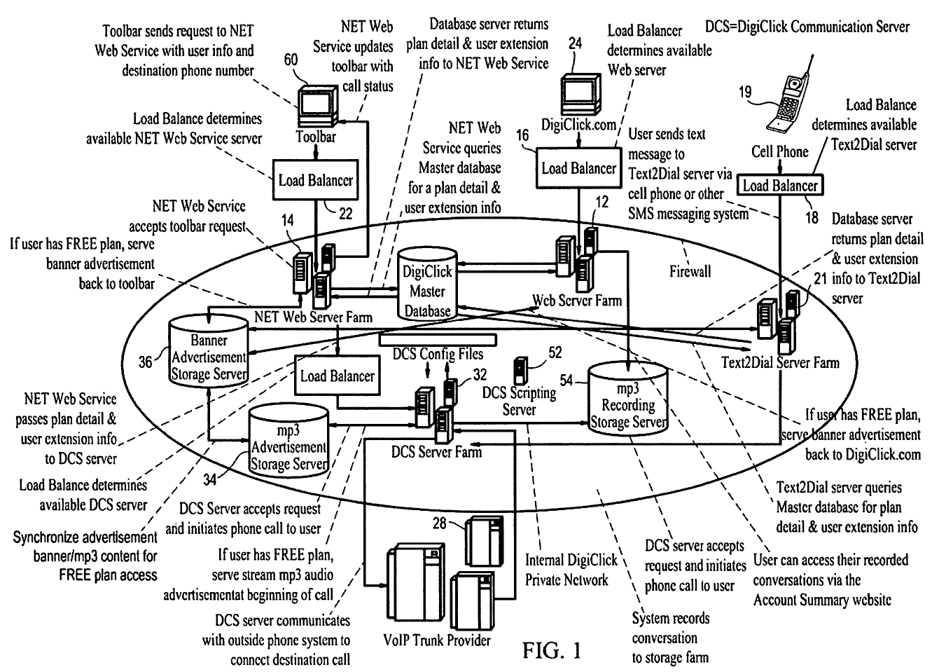

FIG. 1 depicts a system for providing keyword calling as in the present invention. The system comprising: a master database (10); at least one server farm (12, 14, 32); at least one load balancer (16, 18, 20, 22); a web page (24); config files (26); VOIP trunk provider (28); at least one advertisement storage server (34, 36); and wherein a first user performs an internet search that results in at least one keyword that may be clicked to perform a call request, one of the load balancers (16, 18, 20, 22) determines the available server in the server farm (12, 14, 32) the available server accepts the call request and determines from the master database (10) the first user's plan. The first user has a free plan, the at least one advertisement storage server (34, 36) plays the advertisement (which may be, for example, an audio, video or banner advertisement). The load balancer (20) determines the available server in the at least one server farm (32) and the at least one server farm (32) communicates with a phone system to connect a call to a second user to provide a phone connection. The internet search may be accepted through a toolbar (50) on a user's computer or in a standard web search (such as google). The call request may also be accepted though an input device, such as mobile phone (19) via text message, in which case a load balancer (18) determines the available server on a second server farm (21). There may also be a scripting server (52) for providing messages to users. For example, if the first user texts a userID that is unknown, the system may play a message that says, “User id unknown”. The system may also have an audio call recording storage server (54) for recording the phone connection.

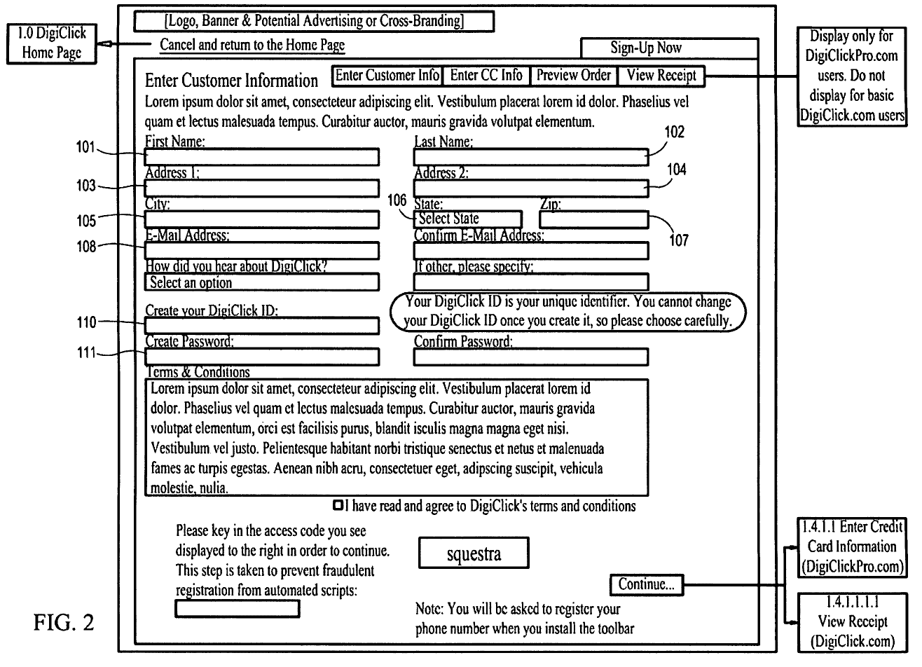

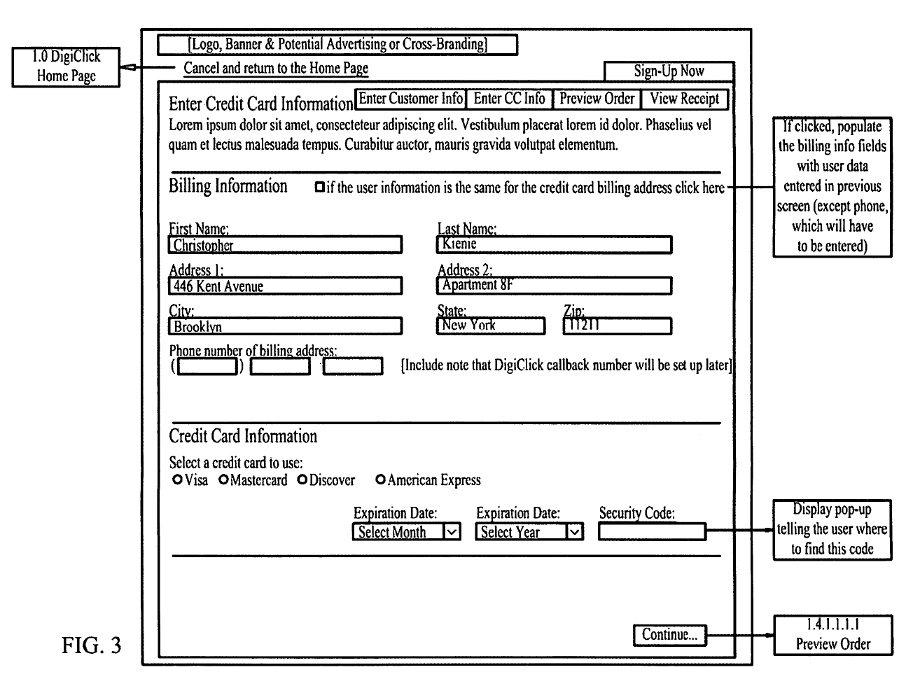

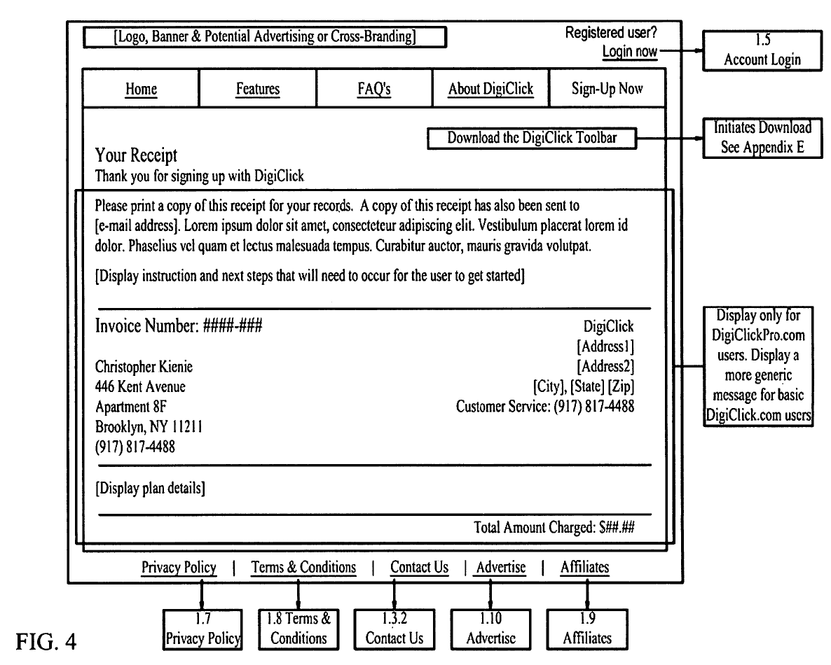

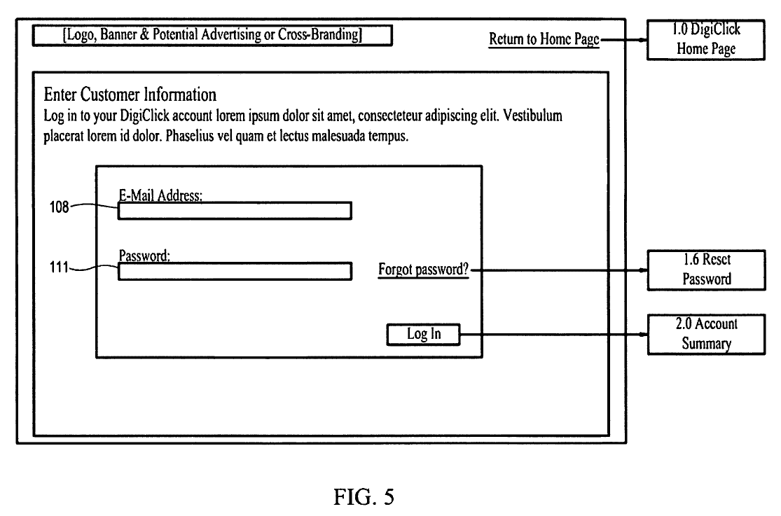

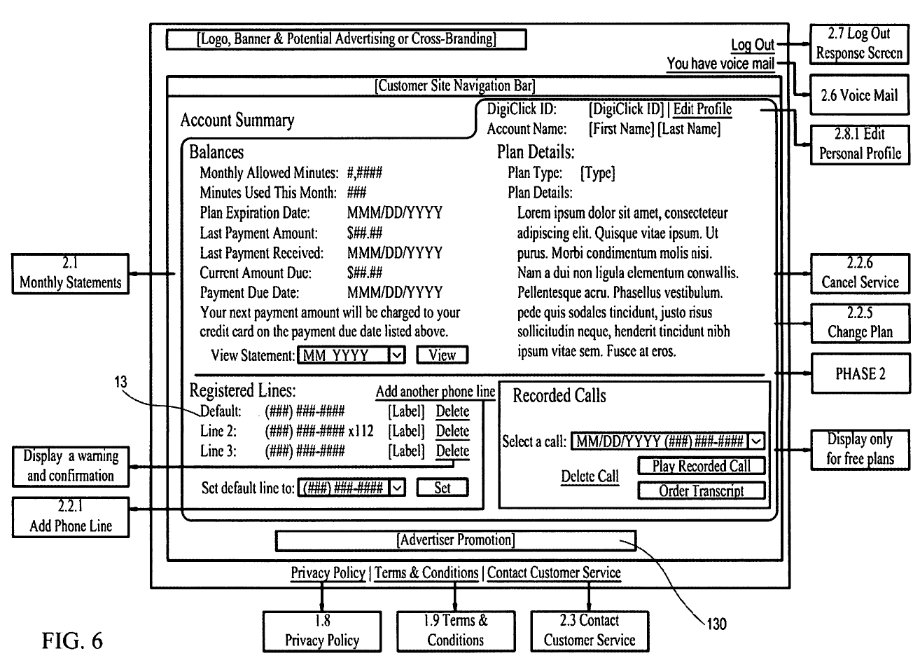

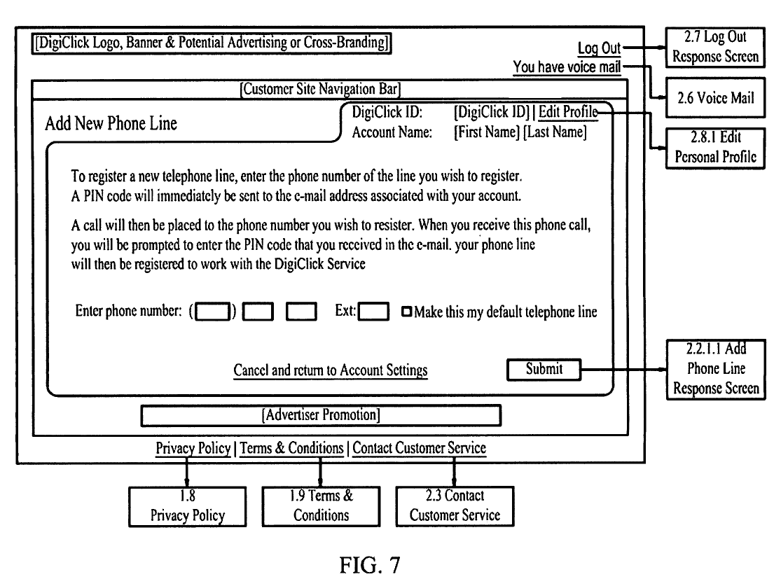

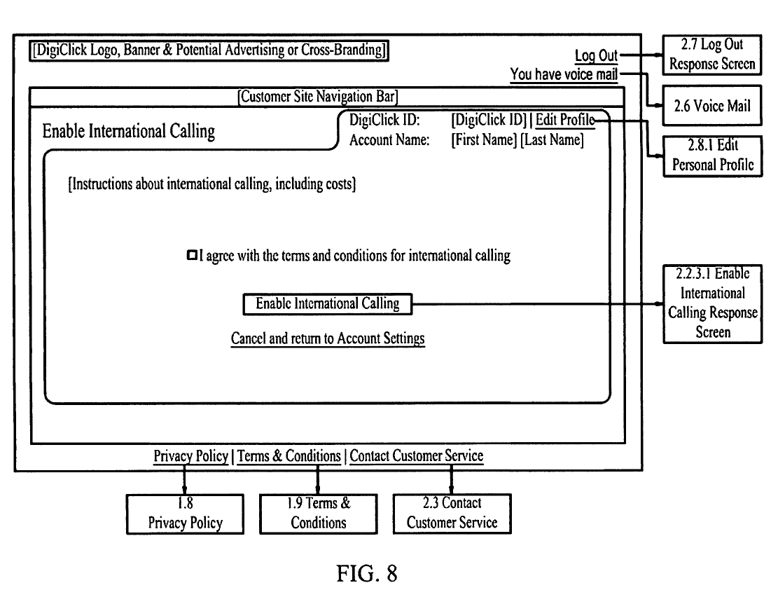

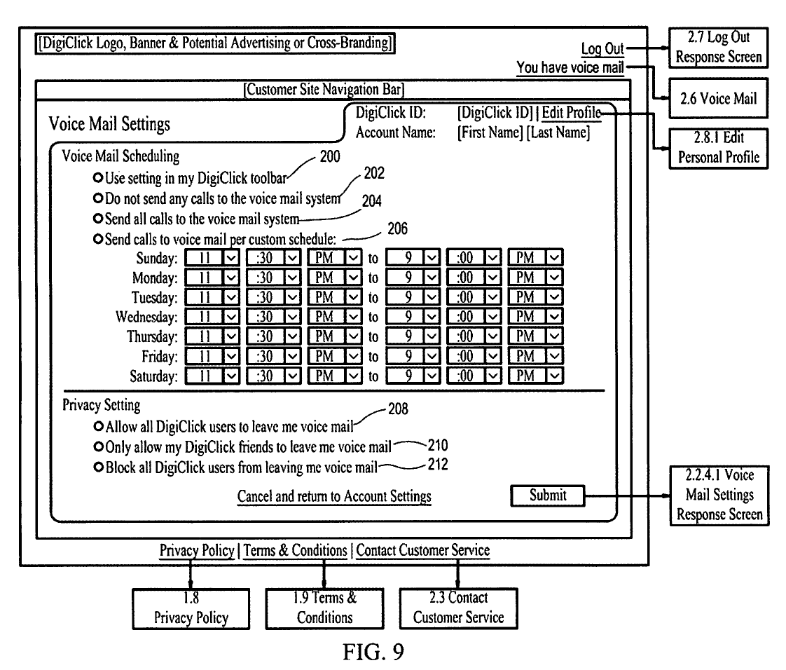

FIG. 2 depicts how a first user may obtain a first user ID. The user may go to a web site on any computer, and input their first name (101), last name (102), address1 (103), address2 (104), city (105), State (106), zip (107), email address (108), firstuser ID (110), password (111). The first user may enter into a paid plan or a free plan. If the first user enters into a paid plan, they are required to input their billing information, as shown in FIGS. 3-4. A call may be initiating by a call requests in a number of different ways. There may be a toolbar (50) installed on the first users computer (a toolbar may also be on the second user's computer). The first user may login, as shown in FIG. 5 by entering their email address (108) and password (111). As shown in FIG. 6, advertisements (130) may be played throughout the users account pages. There may also be a number of different phone numbers (132) associated with a user id. The user selects a first phone number, though, for calls to be received on. This may be changed through the website interface. It is also envisioned that different call features may be used to reach the first user, but at least one first phone number is associated with the first user ID. For example, the first user ID may be associated with three registered lines and ring at all three simultaneously, or call each phone number in order ringing three rings, if unanswered then going to the destination phone number and ringing three rings and if unanswered ringing at the third phone number. At any point, a new phone line can be added (as shown in FIG. 7) or removed. Also, the first user may enable international calling, as shown in FIG. 8. As shown in FIG. 9, the voicemail may also be set according to the user's preferences. For example, the user may request to use the setting in the toolbar (200), do not send any calls to the voice mail system (202), send all calls to the voice mail system (204), send calls to voice mail per custom schedule (206). The user may also select privacy settings, such as allow all registered users to leave voicemails (208), only allow my registered friends to leave voicemail (210), block all registered users from leaving voice mail (212).

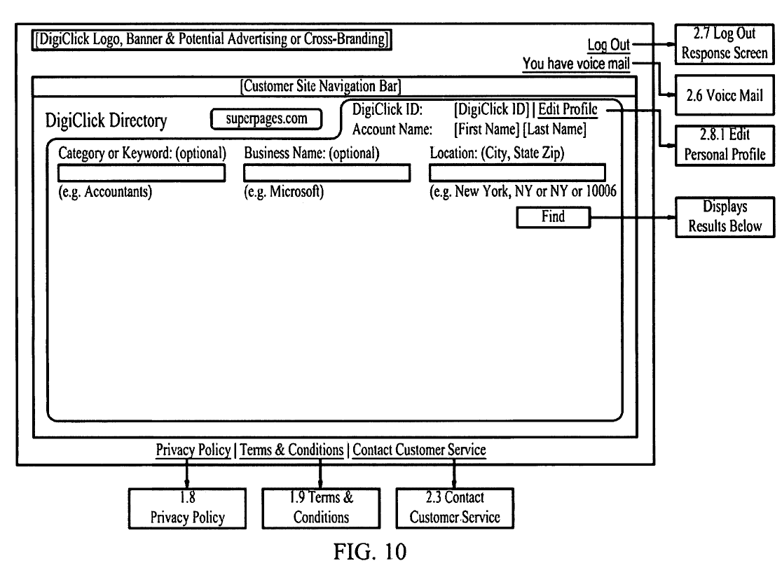

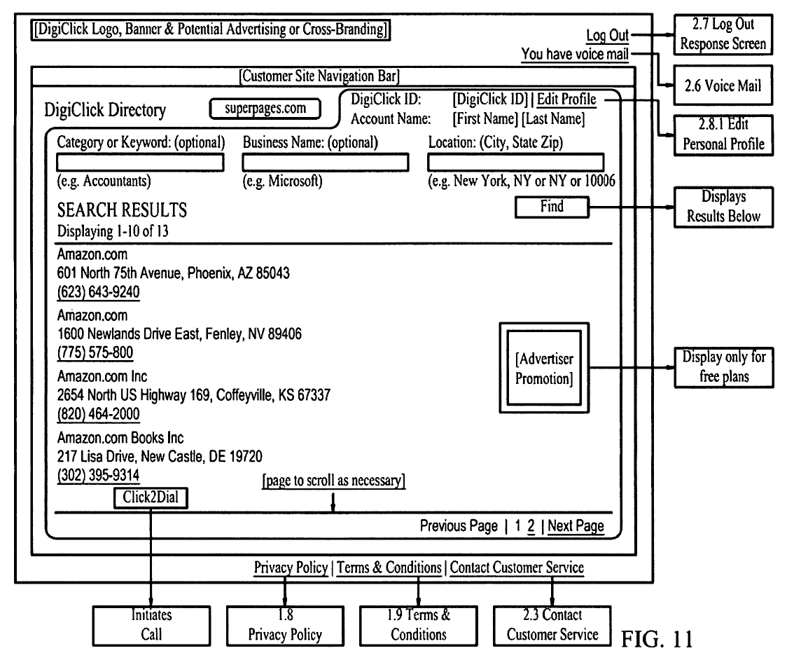

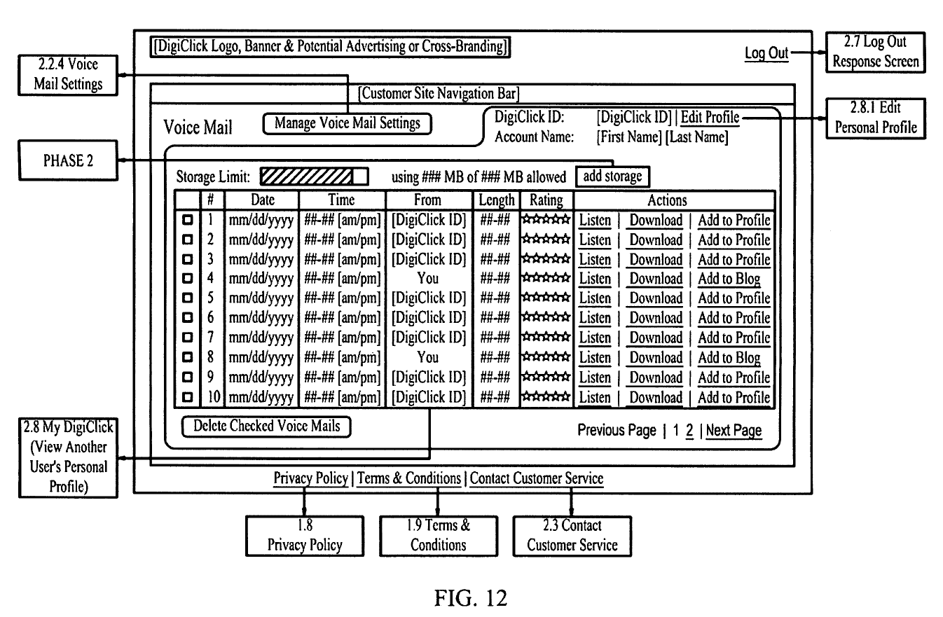

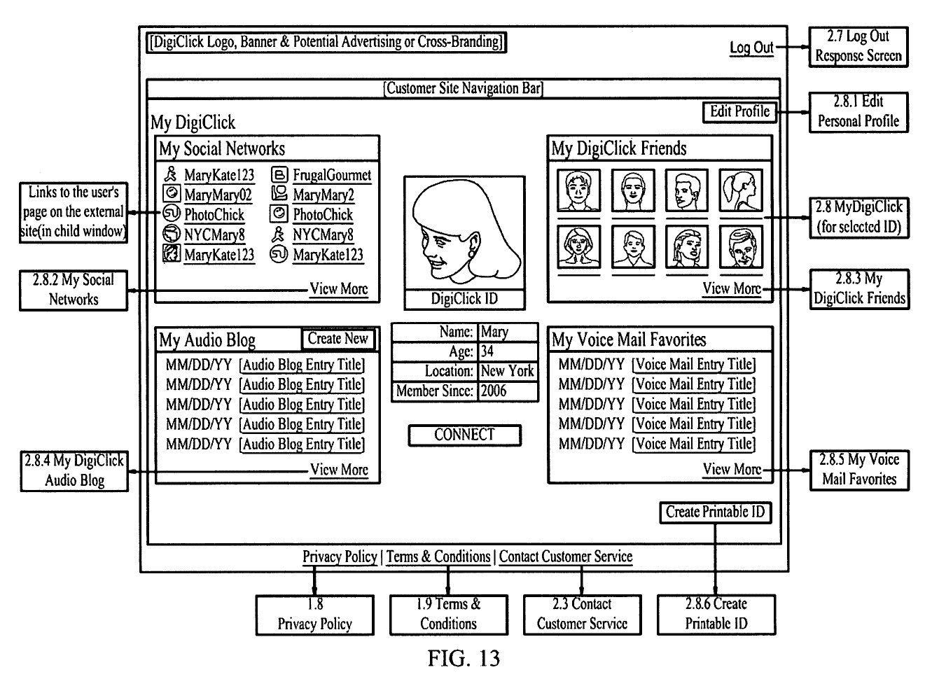

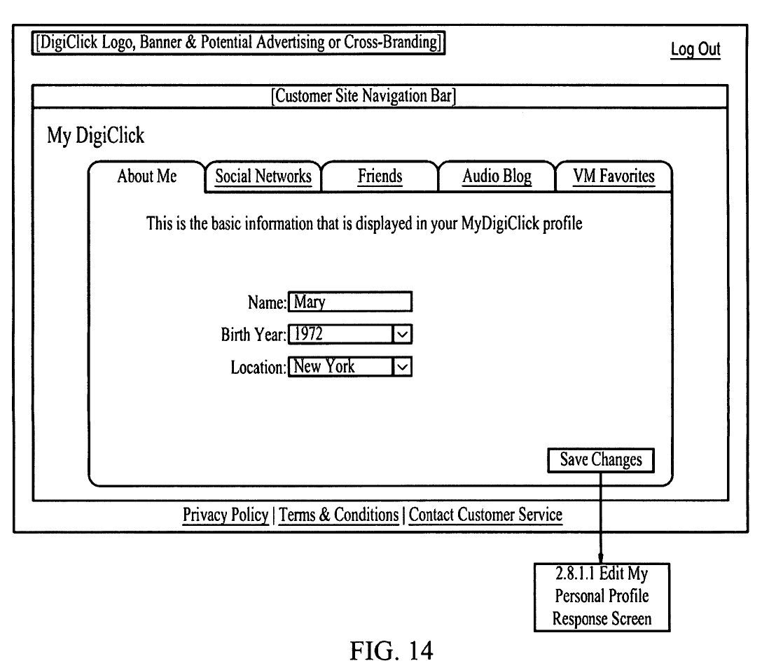

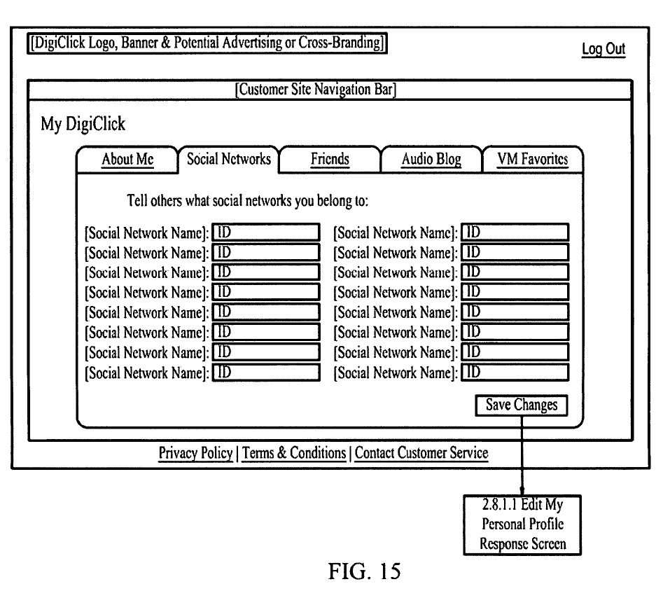

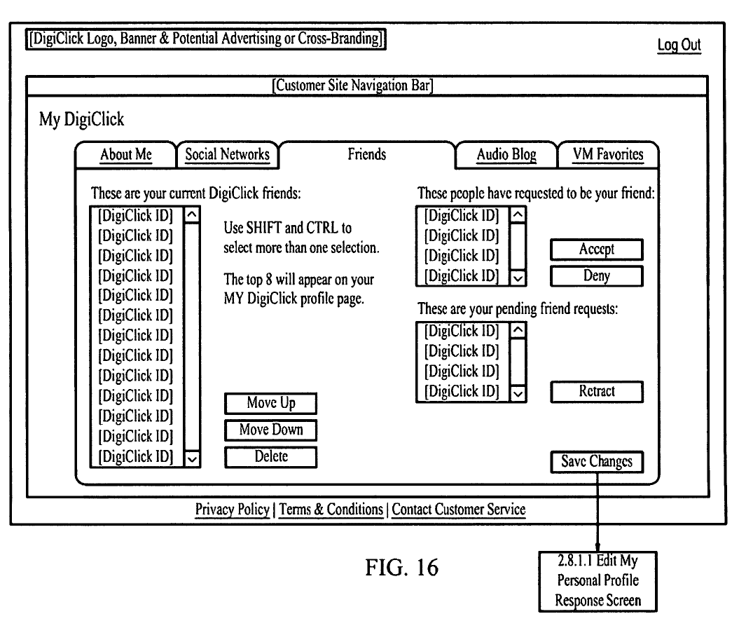

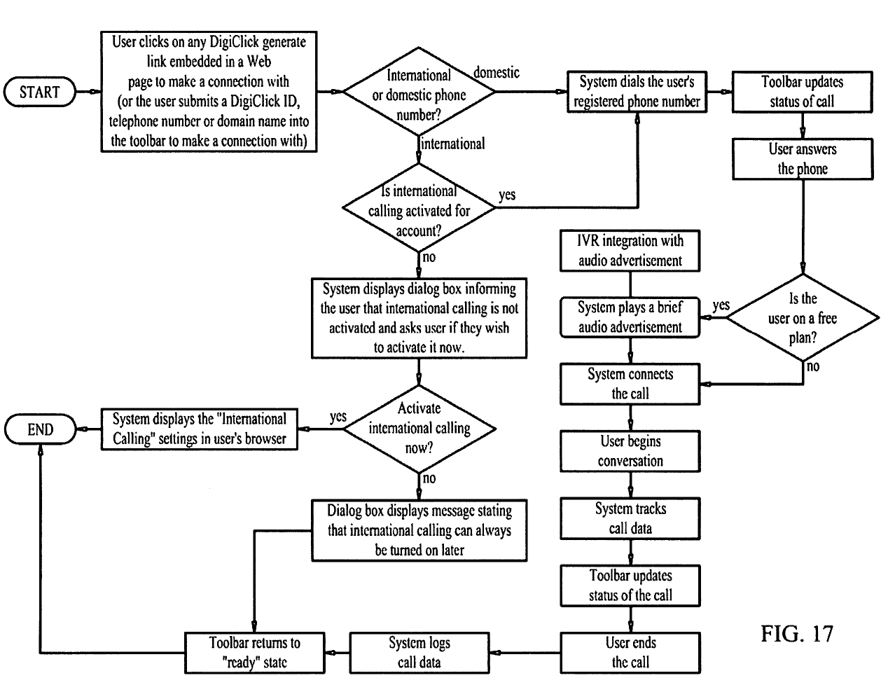

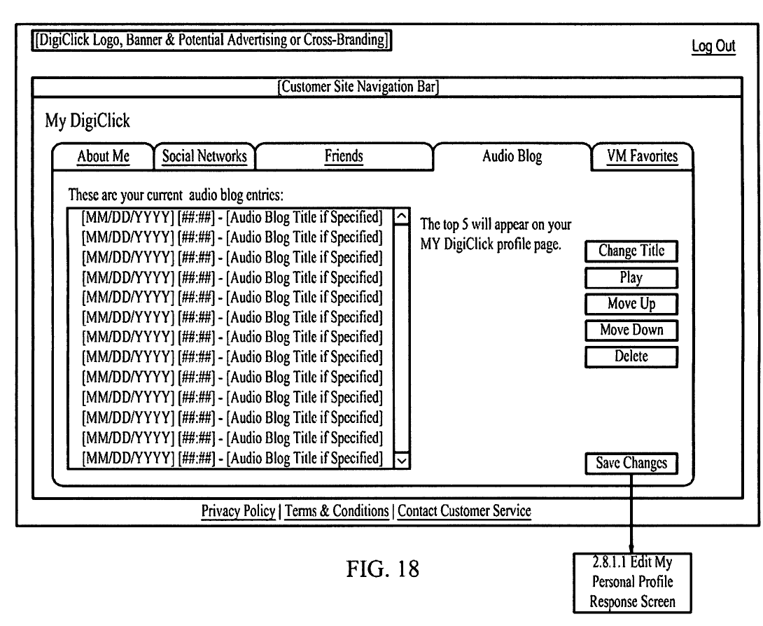

As shown in FIGS. 10-11, there may be a registered user directory showing companies and/or individuals by userID. It may be searched by business type and serve as advertising for the businesses. In this way, user can just click on the business userid, their telephone will ring and the business telephone will ring to connect the user with the business they wish to reach.

According to the present invention, a second user having a second user ID associated with a destination phone number is provided. The second user may wish to receive phone calls regarding goods or services they offer for sale. Currently, users may have to spend a great deal of time and effort optimizing their website to get high ranking on websites, such as Google. The present invention, though, allows the second user to select keywords that when a first user searches and the results have those keywords result in a highlighted keyword, which when clicked on by the first user connects a phone call between the first user's phone number and the second user's phone number. According to this method, a computer implemented method of directly providing a telephone call according to internet keyword searches is provided, the method comprising the steps of: providing a first user having a first user ID associated with a first phone number and a first user plan stored in a first computer based system; providing a second user having a second user ID associated with a destination phone number and a second user plan in the first computer based system, wherein the second user has selected at least one keyword to be associated with the second user ID associated with a destination phone number to provide at least one paid keyword; accepting an internet request on a second computer based system containing at least one keyword from said first user wherein said second computer based system highlights at least one keyword on the first user's computer wherein said internet request contains at least one keyword identical to the at least one paid keyword (selected by the second user) to provide a highlighted keyword; and wherein the first user clicks on the highlighted keyword a call request is initiated, the first computer based system calling the first phone number and the destination phone number associated with the paid keyword and connecting a telephone call between the first user and the second user according to the paid keyword and the call request.

This may be an individual, for example a first user does a google search (or a search in a toolbar) of the terms “Golf Clubs”. A second user may have paid for the terms “Golf Clubs” as they sell golf clubs. Thus, when the first user does a google search for the term Golf Clubs, the term Golf Club is highlighted in some way. The highlight may be an icon may come up next to the term, it may be a double underline, or an underline of a different color, it could be any manner of differentiating the term from other terms on the webpage. According to a preferred embodiment, an icon may be displayed on the webpage anytime the terms “Golf Clubs” appears. The first user may click on the individual results in the same manner they would always look for information via an internet search. However, if they are looking for a quick phone number and do not want to search through multiple layers on pages, they can just click on the keyword and their telephone will ring. Once the first user picks up the telephone, the computer based the method may comprise the step of determining whether the first user is on a paid plan or a free plan. If the first user is on a free plan, an advertisement is played to the first user or initiating user prior to placing phone call and wherein the first user is on a paid plan the advertisement is not played and the first user is called. The advertisement may be played on the users mobile phone, any hand held device or computer, or any of these methods simultaneously depending on the advertiser and whether the first user is inputting the call request in their computer or their mobile telephone. Then the step of calling the destination phone number is performed to provide a phone connection between the first user and the destination phone number. This is useful because it uses a first user and second users existing telephones. That is, they can have any type of phone and the system will call that phone number. It could be a mobile phone, a VOIP phone, a standard land line, any technology the user prefers.

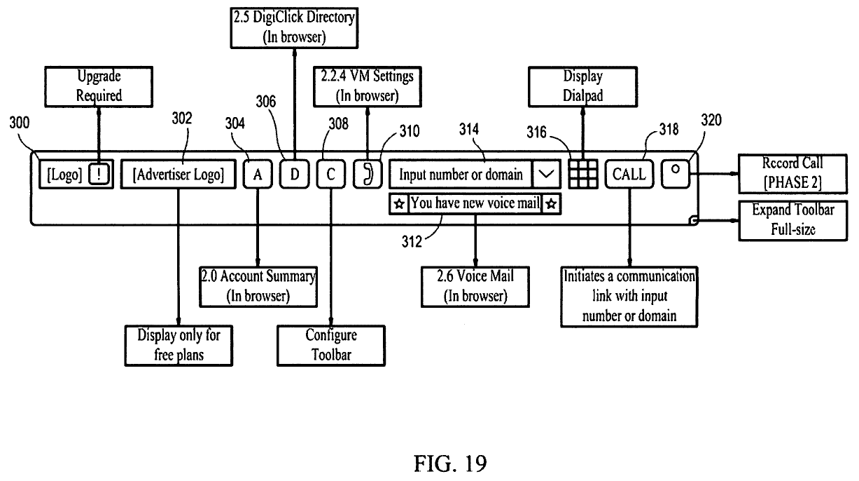

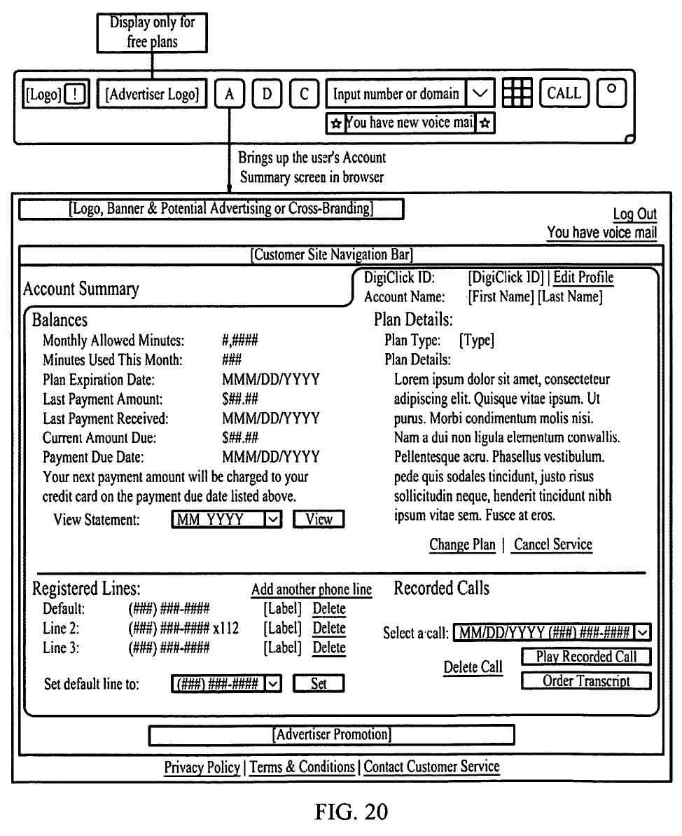

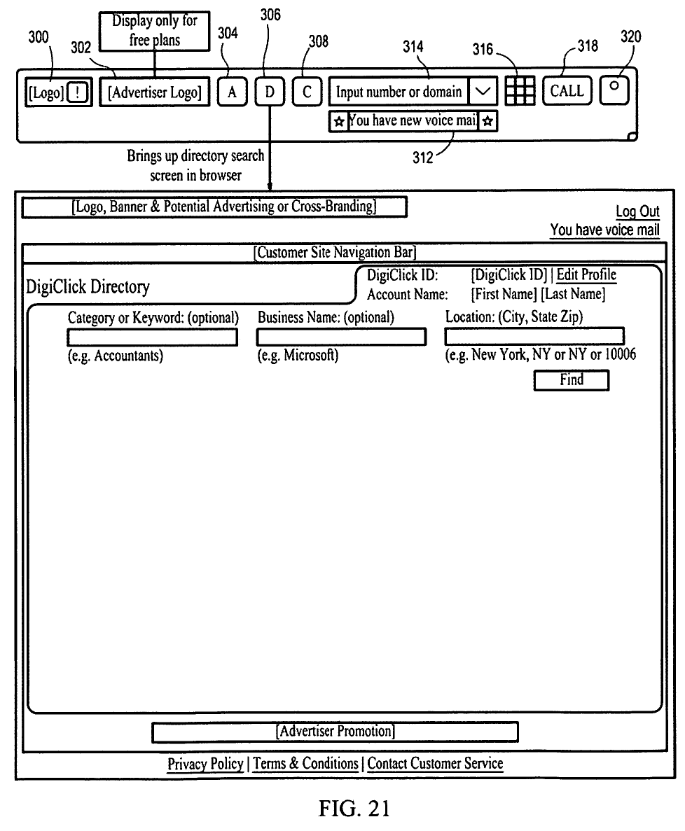

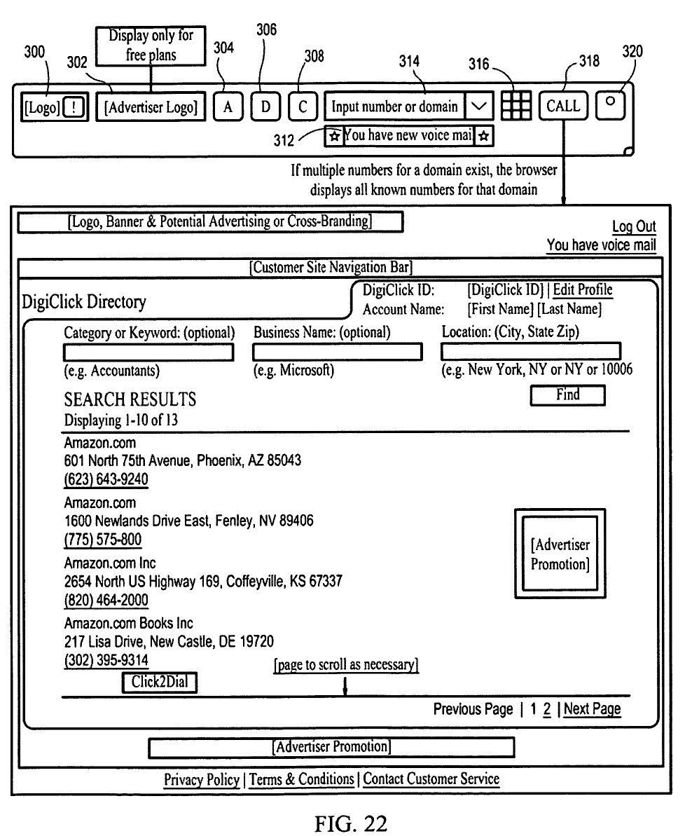

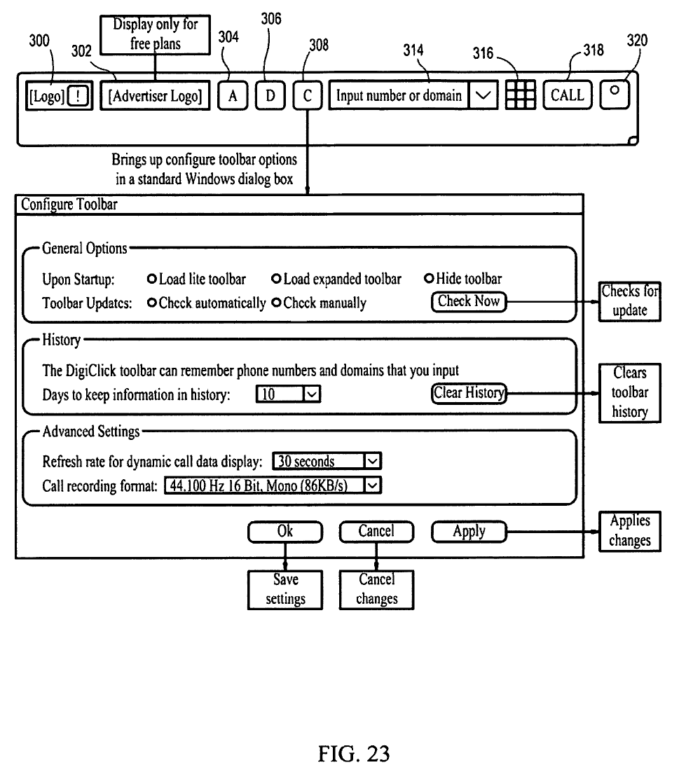

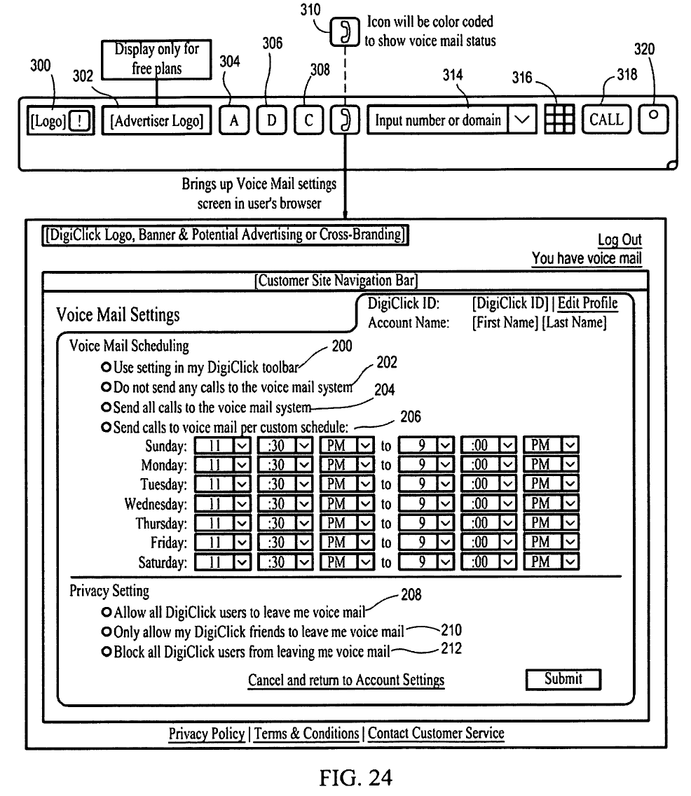

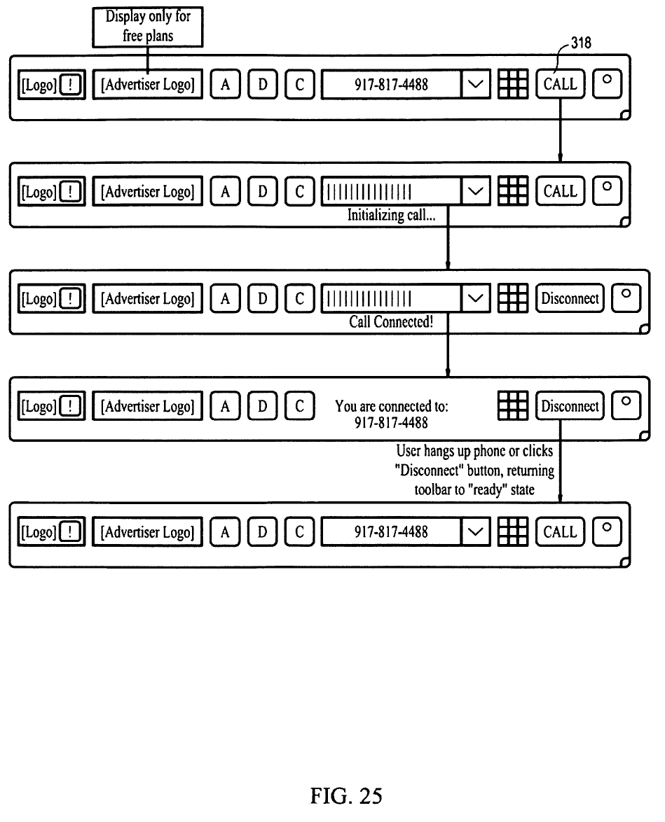

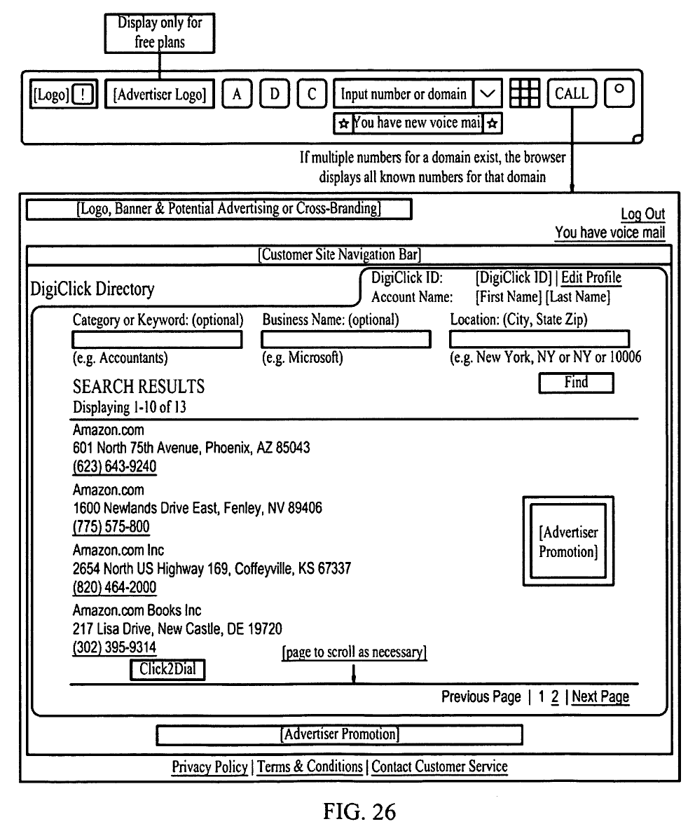

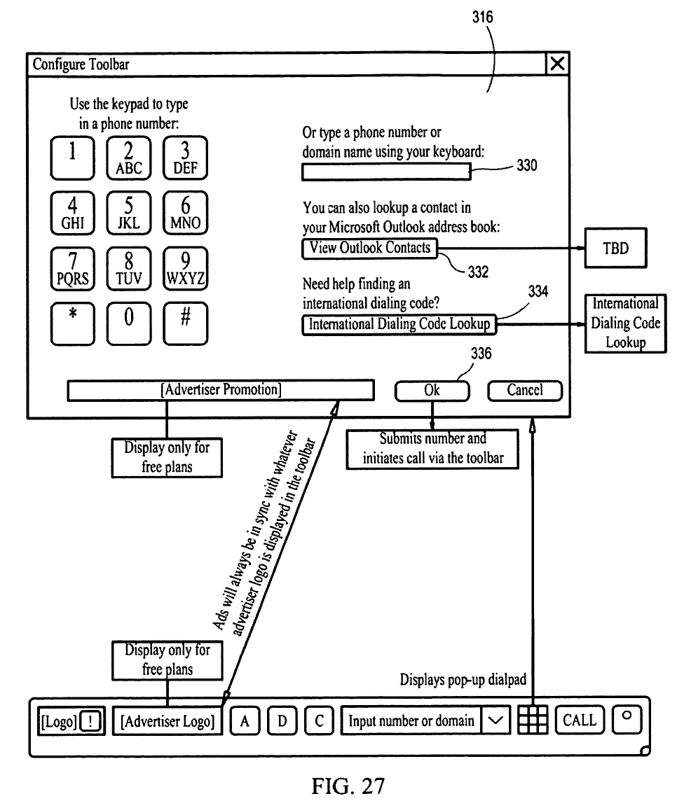

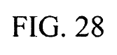

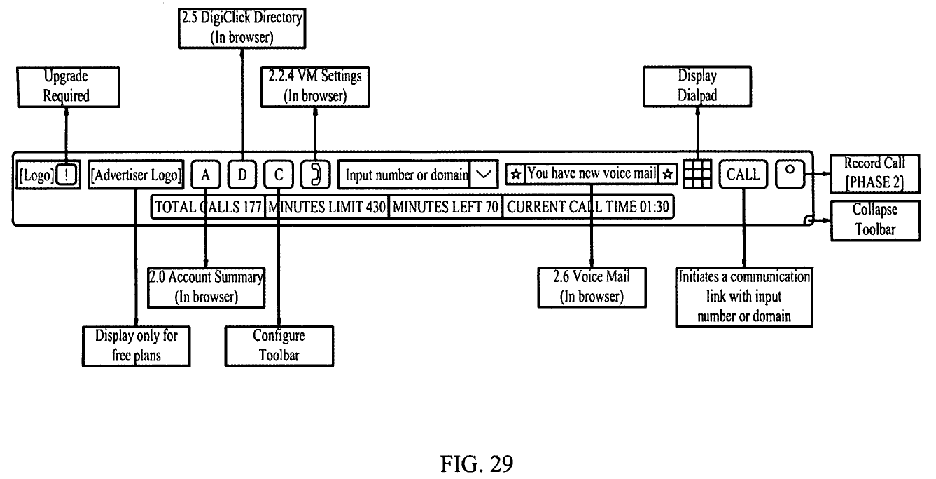

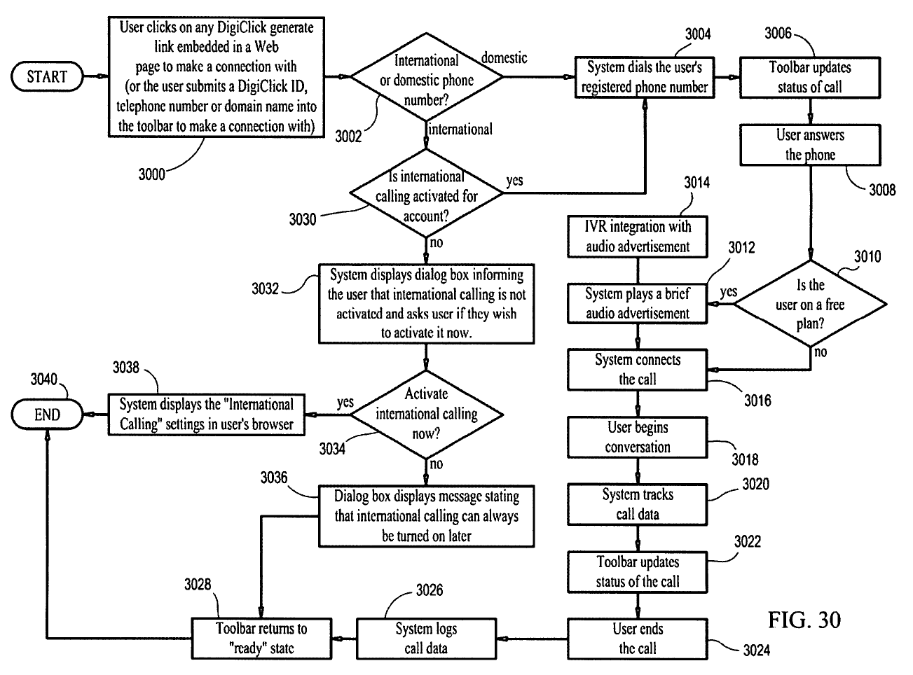

The present invention also envisions a call center, in which users can track and record the phone connection. Also, the toolbar of either user may update according to the status of said anonymous phone connection. FIGS. 19-29, depicts a toolbar according to the present invention. As shown, there may be a logo (300), an advertiser logo (302), account summary (304), directory (306), configure toolbar (308), voicemail settings (310), voicemail (312), drop down of input number or domain (314), display dialpad (316), record button (320). FIG. 20 depicts a screenshot of what may happen when you click on the account summary (304) button. FIG. 21 depicts a screen shot of what happens when you click on the Directory (306) button. FIG. 22 depicts the call (318) button screenshot. FIG. 23 depicts a screen shot of the configure toolbar (308). FIG. 24 depicts the voicemail settings (310) screen shot. FIG. 25 depicts the step of updating the toolbar according to the status of the phone connection. As shown, the user may click on the call (318) button. The drop down of the input number or domain or user id (314) may then indicate that the computer based system is initiating the call. At this point the toolbar display changes to show the call status and the call (318) button may change to say disconnect and show the number that the user is connected to. When the user hangs up the call button (318) may switch back to say call and numbers and or userID's may be stored in the drop down (314). FIG. 27 depicts the dialpad (316). As shown, you call dial in the numbers, type in the phone number or userID (domain) (330), you can also lookup a contact in your Microsoft outlook or other program (332), also you can connect to an outside or internal directory (334). FIG. 28 depicts a country code lookup, you can input the country you wish to call the city and input the local number (334) and press call (344). The computer based system will formulate the number to call and call the first user and the second user to connect the callers. FIG. 39 depicts a sample flowchart of a call from the toolbar and/or dialpad (316).

The method may comprise the step of tracking the anonymous phone connection and recording the anonymous phone connection. The data regarding the length of the call and an audio clip of the actual phone connection may be stored on either users account and viewable on their webpage. Also there may be the step of updating the toolbar of the first user according to the status of the anonymous phone connection.

The advertisement may be played on the on the first users or second users cell phone, hand held device, or computer. The method may comprise the step of tracking the telephone call. Information regarding the anonymous phone connection may be stored in the users account web page. The method may further comprise the step of updating the toolbar of the initiating user according to the status of the anonymous phone connection. The toolbar of the destination phone number may also be updated according to the status of the anonymous phone connection. Once the call is ended, the toolbar may return to the ready state.

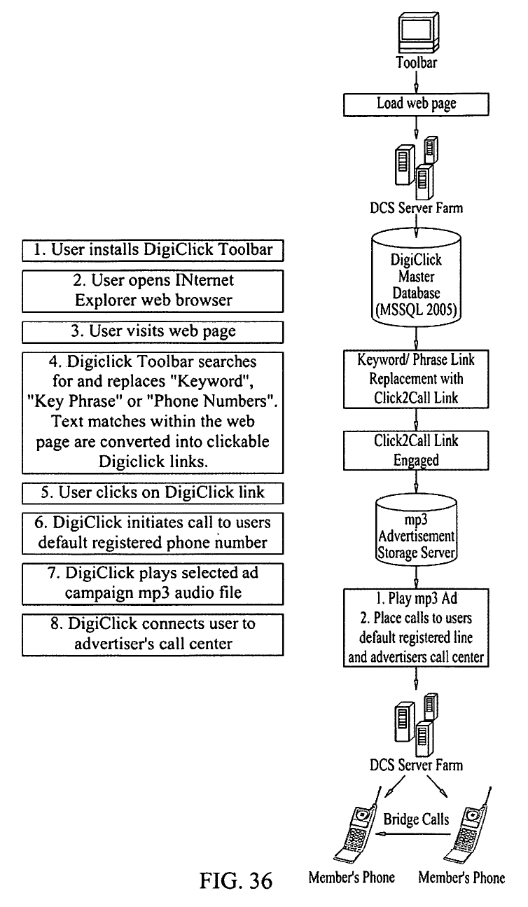

It may also be necessary to provide the step of: determining the destination phone number locale status (3002), wherein the destination phone number locale status is either domestic or international; wherein the destination phone number locale status is international, the method further comprises the step of determining the initiating users membership status (3030), the initiating users membership status being selected from the group consisting of registered and paying, registered and free or unregistered; and wherein the membership status is registered and paying the step of calling the destination phone number is completed (3004, 3006, 3008, 3010, 3016); wherein the membership status is registered and free the step of playing an advertisement to the user is performed and the step of calling the destination phone number is completed(3004, 3006, 3008, 3010, 3012, 3016); wherein the membership status is unregistered, the initiating user is directed towards a membership application (3032) and the step of calling the destination phone number is not completed until the membership status is either registered and paying or registered and free. The advertisement when the phone number locale status is international may be a longer advertisement or a more expensive advertisement. Also, the user may chose not to activate international calling (3036) and may be provided with a message that international calling may be turned on at a later time, the tool bar returns to ready status (3028) and the process is ended (3040). The method may also comprise the step of accepting an input from the first user's phone in response to the step of playing an advertisement. For example, the ad may say “American Airlines e-savers for this week are $69 from New York to Los Angeles, press “1” to make a reservation”. This may be accomplished via IVR integration (3014) with the audio advertisement. FIG. 36 depicts a sample IVR system menu. As shown, the system may play a brief audio advertisement (3600). The system presents IVR system menu (3602). The user may press or say 1 (3604). The DCS requests advertiser's information template (3612), the DCS looks up subscriber's email address (3614), IVR plays configuration of the request as the DCS emails the advertisers information to subscriber (3616). It the user selects “2” (3610), the DCS requests advertisers preset telephone number (3628), the DCS connects user with the advertisers preset number (3630). If the user selects “3” (3608), the DCS request the advertisers URL (3620), the DCS sends the request to the .NET services (3622), the .NET services sends command to the toolbar (3624), IVR plays audio confirmation of the request as the user's toolbar opens the advertisers website is in a new window (3626). If the user selects “3” (3608), the DCS requests advertiser's URL (3620), DCS sends request to .NET services (3622), .NET services sends command to toolbar (3624), IVR plays audio confirmation of the request as the user's toolbar opens the advertisers website in a new window (3626). As in any of the phone connections, it is envisioned that the method may comprise the step of recording the telephone call and providing information on all phone connections such as the length of the call.

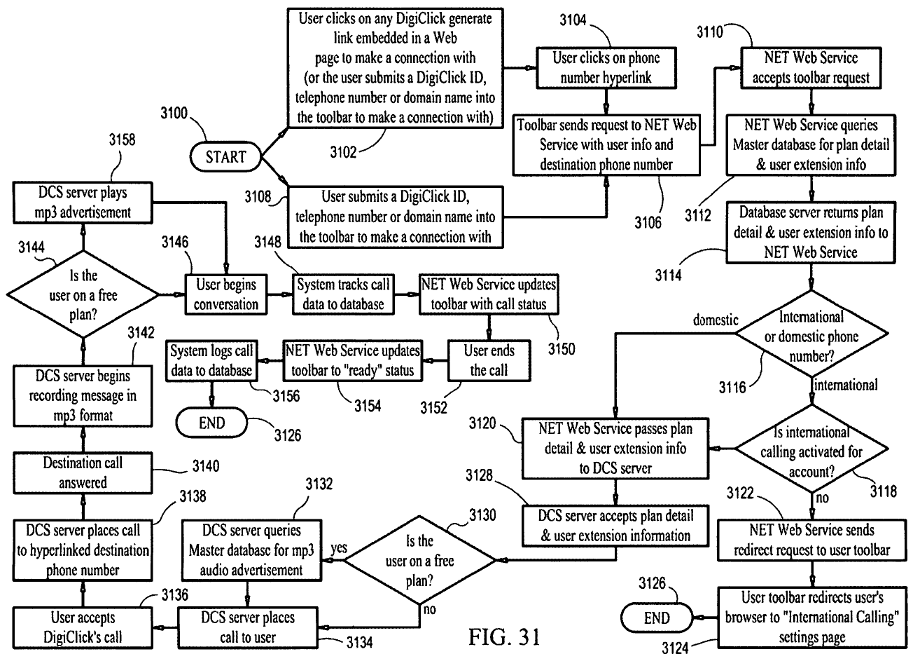

FIG. 31 depicts the manner in which the system may perform the method according to the present invention. As shown, the toolbar may parse the web page (3102) to make all phone numbers and paid keywords clickable hyperlinks. The user may click on the phone number and/or paid keyword hyperlink (3104). The toolbar send the request (3106) to the .net web service with user info and destination phone number. The *net web service (3110) accepts the request (3110). The .net web service queries the mater database for plan detail and user extension info (3112). The database server returns plan detail and user extension for to the .net web service (3114). It is determined if the call is domestic or international ((3116). If the call is domestic, the .net web service passes plan detail and user extension info to the DCS server (3120). The DCS server accepts the plan detail and user extension information (3128). It is determined if the user is on a free plan (3130). If the user is on a free plan, the DCS server queries the Master database for an .mp3 audio advertisement (3132) Then the DCS server places the call to the first user (3134). If the user is not on a free plan, the DCS server places the call to the second user (3134). The first user accepts the call (3136), the DCS server places the call to the second or destination phone number (3138). The second user answers the call (3140). The DCS server begins recording in .mp3 format (3142). The system determines if the second user is on a free plan (3144). If the second user is on a free plan the DCS server plays an advertisement (3158). If the second user is not on a free plan, the conversation begins (3146) without playing an advertisement. The systems tracks call data to the database (3148), the .net web service updates the toolbar with call status (3150). When the user ends the call I(3152), the .NET web service updates the toolbar to “ready” state (3154), the system logs the call data to the database (3156) and the call is ended (3126).

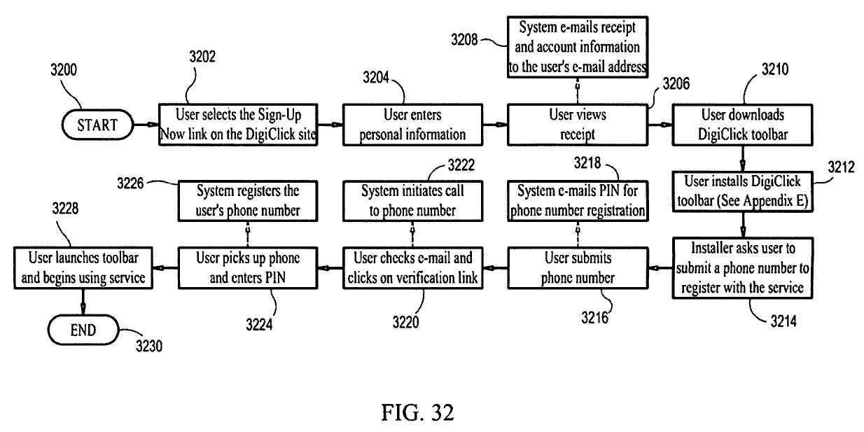

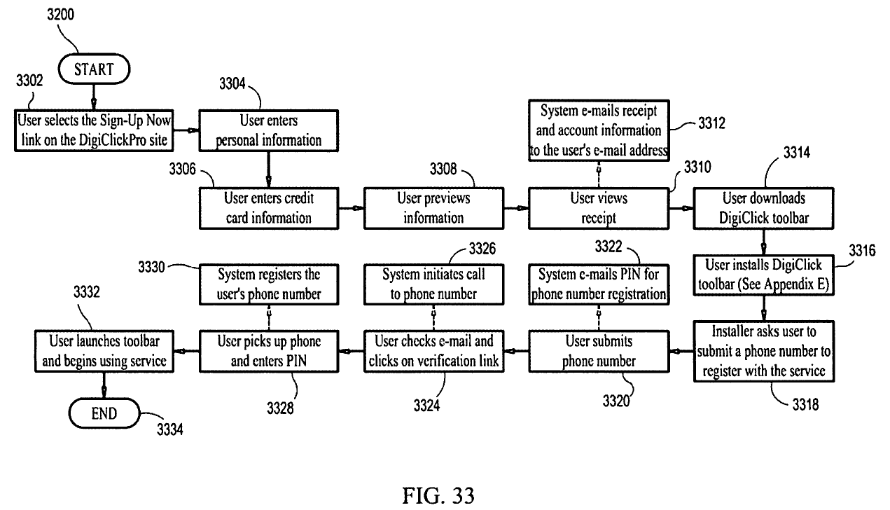

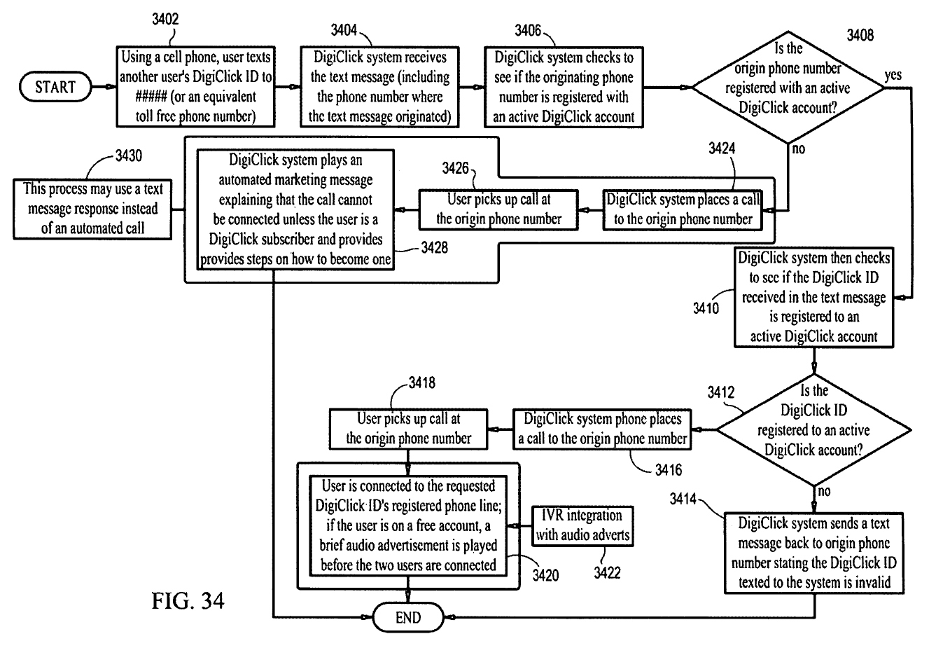

FIGS. 32-33 depicts the process of signing up to be a registered user. As shown, the user selects the sign-up now link on the website (3202). The user enters their personal information (3204). The user views the receipt (3206). The system emails receipts and information to the users account (3208). The user may also download the digiclick toolbar (3210). The user may install the toolbar (3212). The installer asks to submit a phone number (3214). The user submits a phone number (3216). The system emails a PIN for phone number registration (3218). The user checks email and clicks on verification link (3220). The system initiates call to phone number (3222). The user picks up phone and enters pin (3224), the system registers the user's phone number (3226). The user launches the toolbar and begins using service (3228). FIG. 33 depicts a higher level or Digiclick Pro account. As shown, the user selects the sign-up now (3302). The user enters information (3304), the user enters credit card information (3306), the user previews the information (3308), the user views the receipt (3310), the system emails the receipt and account information to the user's email address (3312). The user downloads the digiclick toolbar (3314), the user installs the toolbar (3316), the installer asks for a phone number (3318), the user submits the phone number (3320), the system emails a PIN for phone registration (3322), the user checks email and clicks on verification link (3324), the system initiates call to phone number (3326), the user picks up the phone and enters PIN (3328), the system registers the user's phone number (3330). The user launches the toolbar and begins using service (3332).

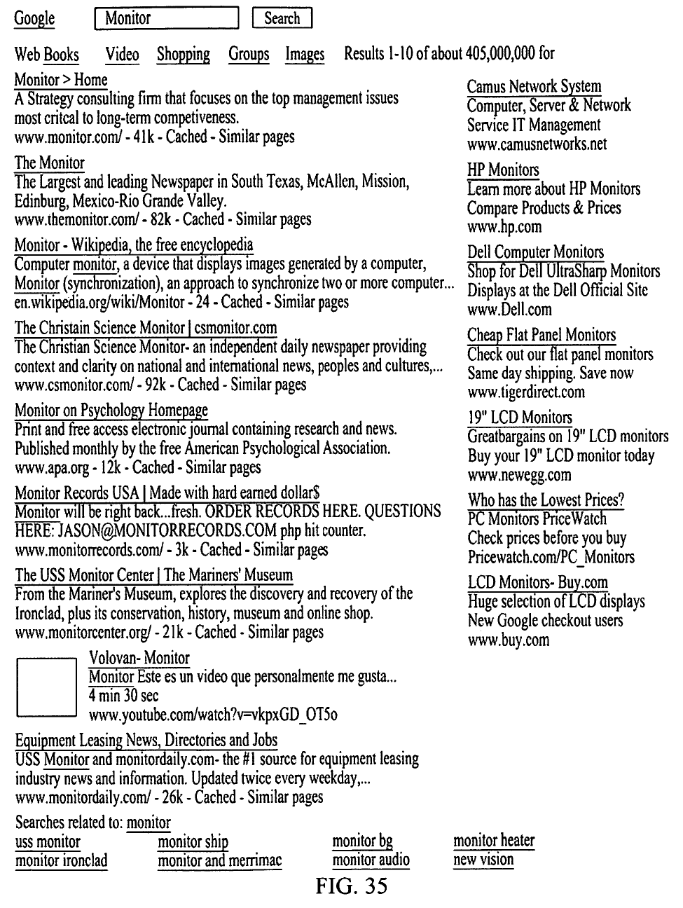

As shown in FIG. 35-36, a computer implemented method of directly providing a telephone call according to internet keyword searches, the method comprising the steps of: providing a first user having a first user ID associated with a first phone number and a first user plan stored in a first computer based system; providing a second user having a second user ID associated with a destination phone number and a second user plan in the first computer based system, wherein the second user has selected at least one keyword to be associated with the second user ID associated with a destination phone number to provide at least one paid keyword; accepting an internet request on a second computer based system containing at least one keyword from the first user wherein the second computer based system highlights at least one keyword and wherein the internet request contains at least one keyword identical to the at least one paid keyword to provide a highlighted keyword (see FIG. 35, every instance of the word Monitor has an icon next to it, the icon highlights the keyword monitor) and wherein the first user clicks on the highlighted keyword (in the FIG. 35, monitor) a call request is initiated, the first computer based system calling the first phone number and the destination phone number associated with the paid keyword and connecting a telephone call between the first user and the second user according to the paid keyword and the call request.

The first user plan may be free, free and international, paid, paid and international. The first user toolbar resident on the first user's computer. A second user toolbar may be resident on the second user's computer. The second user may just have a standard telephone and purchase at least one keyword, they do not necessary have to have a toolbar or any webpage component. It should be understood that the paid keyword may be leased, purchased outright, paid for per click, paid for according to purchases resulting from the call or any other payment structure.

The registration status of first user should be determined, including at least whether the first user is on a paid plan or a free plan, and wherein the first user is on a free plan, an advertisement is played to the first user prior to placing the phone call. If the first user is on a paid plan the advertisement may not be played and the first user is called. The second user, who is trying receive phone calls for business may also pay for the phone call. It may be important to determine if the destination phone number is a domestic or international call to the first user. As the internet is global, keywords may also be purchased according to the geographic location of the first user. Also, the second user may have an certain dollar amount that they attribute to an average phone call and may not want to accept phone calls that are more expensive. The phone call may be a telephony or VOIP call, however, there may be additional charges to connect to land lines. Also, the second user may have a local business (such as a New York City Restaurant) and not be interested in any searcher (first user's) in Germany. Accordingly, the second user may select paid keywords wherein the first user is located within a geographic area. In the example provided, only around the New York City area.

The advertisement may be selected according to many criteria including the first user's plan, the second user's plan, the estimated cost of the telephone call, the actual cost of the telephone call, the product offered by the second user and the service offered by the second user. The second user may be willing to pay more for keywords where the potential product or service is a bigger ticket item. For example, a Mercedes Benz dealership may be willing to pay more for a keyword search than a restaurant, as presumably the amount of money made on the sale of a Mercedes is greater than a meal.

There may be a toolbar resident on at least one of the first user's computer and the second user's computer. The toolbar may be updated according to the status of the telephone call. The call request may also be requested via a mobile device and may be anonymous to at least one of the first user and the second user. The telephone call may also be tracked and recorded.

There may be the step of accepting an input from the first user's phone in response to step of playing an advertisement. For example, the second user may pay to have the phone call directed to them. Also, the phone call may be international and the first user may be on a free plan, in which case an advertisement may be played. The first user may decide they want to purchase whatever is being sold by that advertisement. They may be prompted to press one to continue with the original call, or press 2 to purchase whatever is being offered by the advertisement.

There may be the step of emailing at least one of the keyword and telephone number called to the first user.

It should be understood that the foregoing relates to preferred embodiments of the invention and that modifications may be made without departing from the spirit and scope of the invention as set forth in the following claims.

I claim:

1. A computer implemented method of directly providing a telephone call according to internet keyword searches, said method comprising the steps of:
providing a first user having a first user ID associated with a first phone number and a first user plan stored in a first computer based system;
providing a second user having a second user ID associated with a destination phone number and a second user plan in said first computer based system, wherein said second user has selected at least one keyword to be associated with said second user ID associated with a destination phone number to provide at least one paid keyword;
accepting an internet request on a second computer based system containing at least one keyword from said first user wherein said second computer based system highlights at least one keyword and wherein said internet request contains at least one keyword identical to said at least one paid keyword to provide a highlighted keyword; and
wherein said first user clicks on said highlighted keyword a call request is initiated, said first computer based system calling said first phone number and said destination phone number associated with said paid keyword and connecting a telephone call between said first user and said second user according to said paid keyword and said call request.

2. A computer implemented method as in claim 1, further comprising the steps of determining the registration status of said first user including at least whether said first user is on a paid plan or a free plan, and wherein said first user is on a free plan, an advertisement is played to said first user prior to placing said phone call.

3. A computer implemented method as in claim 1, further comprising the steps of determining the registration status of said first user including whether said first user is on a paid plan or a free plan, and wherein said first user is on a paid plan said advertisement is not played and said first user is called and said first user is billed for said phone call.

4. A computer implemented method as in claim 1, further comprising the steps of determining whether said destination phone number is a domestic or international call to said first user and said computer based system initiates a call by calling said first phone number and said destination phone number and connecting said first user and said second user to provide an phone connection between said first user and said destination phone number.

5. A computer implemented method as in claim 2, wherein said first user plan is selected from the group consisting of free, free and international, paid, paid and international.

6. A computer implemented method as in claim 2, wherein the advertisement is selected according to at least one of said first user plan, said second user plan, the estimated cost of the telephone call, the actual cost of the telephone call, the product offered by the second user and the service offered by the second user.

7. A computer implemented method as in claim 1, further comprising a toolbar resident on at least one of said first user's computer and said second user's computer.

8. A computer implemented method as in claim 1, further comprising the step of:
updating the toolbar of said first user according to the status of said telephone call.

9. A computer implemented method as in claim 1, wherein said call request is requested via a mobile device.

10. A computer implemented method as in claim 1, wherein said call request is anonymous to at least one of said first user and said second user.

11. A method as in claim 1, further comprising the step of:
tracking said telephone call.

12. A method as in claim 2, further comprising the steps of:
accepting an input from said first user's phone in response to said step of playing an advertisement.

13. A method as in claim 1, further comprising the step of:
emailing at least one of the keyword and telephone number called to said first user.

14. A method as in claim 1, further comprising the step of:
said first user downloading and installing an internet browser plug-in.

15. A computer implemented method as in claim 1, wherein said second user is billed for said telephone call.

16. A computer implemented method as in claim 1, wherein said second user may select paid keywords wherein the first user is located within a geographic area.
